(19) United States
(12) Patent Application Publication
(10) Pub. No.: US 2002/0180796 A1
(43) Pub. Date: Dec. 5, 2002

(54) Database interface system

(76) Inventors: Martin John Millmore, Berkshire (GB); Andrew Richard Rundell, San Francisco, CA (US); John Patrick Bard, Hertfordshire (GB)

Correspondence Address: SWIDLER BERLIN SHEREFF FRIEDMAN, LLP, 3000 K STREET, NW, BOX IP, WASHINGTON, DC, 20007, US

(21) Appl. No.: 09/867,680

(22) Filed: May 31, 2001

(51) Int. Cl. G06F 3/00

(52) U.S. Cl. 345/780

(57) ABSTRACT

A system for enabling entry and/or display of data in a database. The system comprises a processor for controlling the display of a form having a number of data fields corresponding to data items stored or to be stored on a database. A store for storing, for at least one data field, information enabling attributes relating to that data field to be displayed upon user command while the form continues to be displayed is provided.

### FIELD OF THE INVENTION

The invention relates to a system for enabling entry and/or display of data in a database.

Description of the Prior Art

In modern database entry systems such as the Oracle Human Resources it is common to enter a wide variety of data items and typically these are entered via a series of displayed data entry forms. In view of the number of data items involved, it is necessary to enter the data using a number of forms and thus it is not possible to view all the data simultaneously. For example, in the case of personnel records, a first form may be designed to present basic details about the person concerned such as his address, name etc. while subsequent forms can be called up to enable entry of other categories of data such as business details, performance related information and the like.

It is often necessary, when entering data, to view other previously stored data. At present, if that previously stored data is not currently displayed on the form concerned, the user must navigate to another form which contains that data so that he can display it and then, having read it, return to the original form to continue his data entry task. This is clearly undesirable.

For example, if the user was looking at a form which displayed an employee's supervisor, and needed to know the supervisor's home phone number, the user would have to re-query the form to display the supervisor, then from there, navigate to a second form which displays phone numbers. To get back to where they started, they would then have to close the phone numbers form and re-query the first form to re-display the employee.

### SUMMARY OF THE INVENTION

In accordance with the present invention, a system for enabling entry and/or display of data in a database comprises a processor for controlling the display of a form having a number of data fields corresponding to data items stored or to be stored on a database; and a store for storing, for at least one data field, information enabling attributes relating to that data field to be displayed upon user command while the form continues to be displayed.

With this invention, we enable certain attributes which relate to the data field concerned to be displayed while the original form continues to be displayed. In the case of data entry, this enables the user to view other information which he may need to use when entering information on the form while in the case of data display, he can easily call up related information while maintaining the main display.

Typically, the stored information will define one or more data items from the database. However, the stored information could define an algorithm which is run when selected, the result of the algorithm being displayed. For example, if the primary data field is a person's Job then the attribute which is displayed could be set to be data relating the person's performance in that job, for example sales figures. This could either be retrieved directly from the database or, if it does not exist in that form, be computed in accordance with the stored information.

An important aspect of this invention is the use of a store for storing the information. This is used in the preferred aspect of the invention by enabling the processor to provide a user interface to enable a user to define information which is stored in the store corresponding to the at least one data field. This enables the user easily to set up the attributes which are to be displayed in accordance with his particular system.

The processor could be adapted to respond to a variety of user commands such as keyboard entries and the like but in the preferred system, the processor responds to mass commands, the user command comprising a right click of the mouse when the mouse icon is aligned with a data field.

### BRIEF DESCRIPTION OF THE DRAWINGS

An example of a system according to the invention will now be described with reference to the accompanying drawings, in which:

FIG. 1 is a block diagram of the system;

FIGS. 2 and 3 are screen displays produced during operation of the system shown in FIG. 1; and,

FIG. 4 illustrates an example of data stored in the store of FIG. 1.

### DETAILED DESCRIPTION OF THE EMBODIMENT

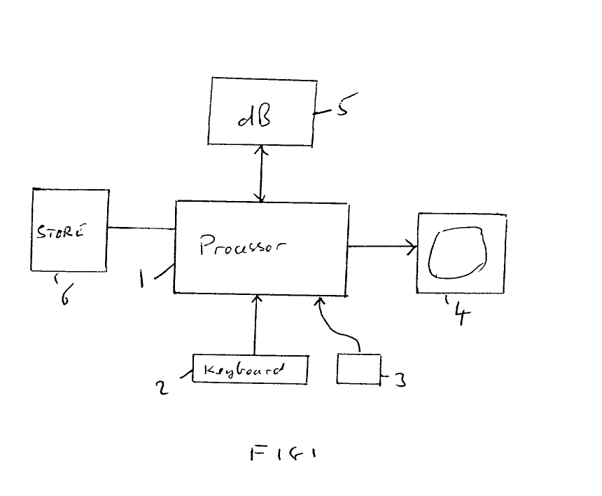

The system shown in FIG. 1 comprises a processor 1 controlled by a keyboard 2 and mouse 3 and connected to a monitor display 4. The processor is connected to a database 5 which may be local to the processor or located elsewhere in the world, the processor being connected to the database 5 via a suitable link such as a telephone line or the like. The database 5 could be located on a single server or distributed across several servers.

In addition, the processor 1 is connected to a store, typically a look-up table (LUT) 6 for storing attribute data relating to certain data fields and data defining the appearance of data fields on forms to be displayed.

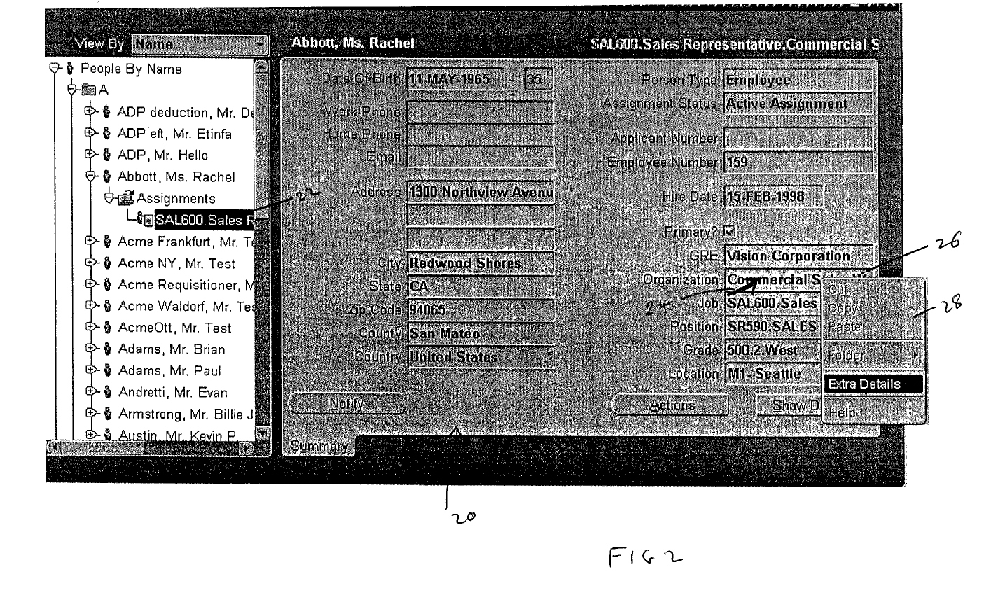

In this example, the system is used to handle personnel records and FIG. 2 illustrates a typical example of a data entry/display form 20 which is produced on the monitor 4 by the processor 1 in response to user selection via the keyboard 2 and mouse 3 and in accordance with data in the store 6 defining the appearance of the data fields. In this case, details about Ms Rachel Abbott have been selected by highlighting an entry 22 in a displayed list. The processor 1 has generated the appropriate form 20 and extracted from the database 5 data items such as date of birth, address and the like which are then displayed in corresponding data fields on the form.

This form can be used not only to display information but also to enable the information to be changed on the database by suitably overtyping the existing information or entering new information in previously unused data fields.

In addition, the user may wish to obtain related information which is not currently displayed on the form. For example, under Person Type, the user may wish to obtain information about previous employment which is contained elsewhere on the database and is normally displayed using a different form.

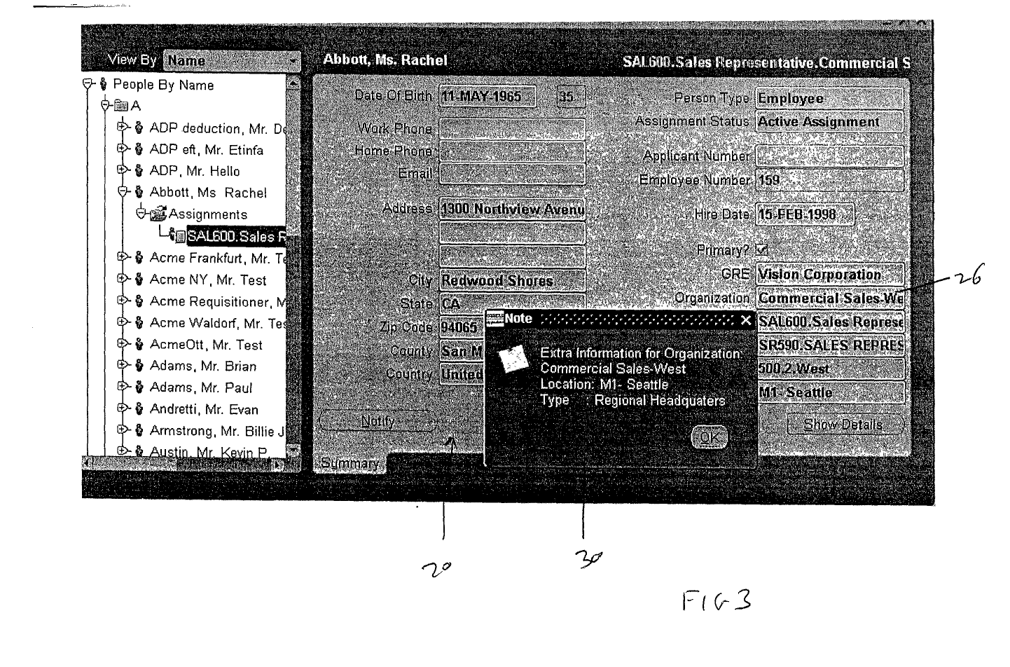

In this example, the user wishes to obtain more information about the “Organization” data field. To obtain this, he moves the mouse 3 to bring a mouse icon 24 into alignment with the Organization data field 26 (FIG. 2) and right clicks the mouse. This brings up an intermediate window 28 with an “Extra Details” entry. The user then brings the mouse icon 24 into alignment with this entry and left clicks which brings up the extra information shown at 30 in FIG. 3. As can be seen in FIG. 3, the extra information includes details of the Location of the organisation and its Type. It will also be noted that the form 20 remains displayed.

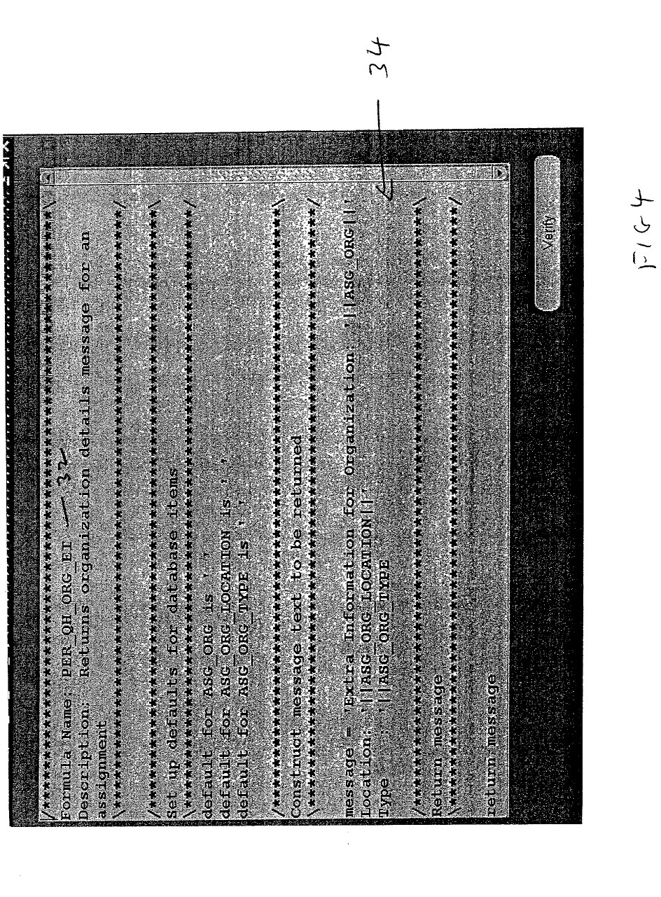

In order to define the information which is to be brought up for this or other data fields, the processor 1 provides an interface which enables the user to enter a set-up routine in which he is able to set up and edit a formula or algorithm defining the extra information. The formula required to achieve the extra information 30 shown in FIG. 3 is illustrated in FIG. 4.

The formula is given a name 32 which defines the data field concerned (in this case data field 26) and various defaults are automatically set by the processor 1.

The user then enters the required information at 34 and it will be seen by comparing the region 34 with the extra information displayed at 30 how these two relate together. When the user is happy with the formula he clicks the Verify button and the information is then stored as attribute data in the store 6.

In use, when the user right clicks against a data field, the processor 1 checks to see whether a formula of the type shown in FIG. 4 has been stored for that data field and, if it has, will cause the window 28 with “Extra Details” to be displayed. The user can then left click on “Extra Details” which will cause the processor 1 to extract the formula from the store 6 and act on it.

In this example, the formula shown in FIG. 4 simply defines other data fields from which information is to be obtained. Thus, for “Location” it instructs the processor 1 to obtain the corresponding location data for the organization stored with the assignment “ORG_LOCATION” and for organization type to extract the information with the data field name “ORG_TYPE”. In more sophisticated examples, the formula may define an algorithm which carries out a computation based on data values obtained from the database. This might, for example, include average monthly sales figures for the person concerned when the only information stored is the actual monthly sales figures. The computation defined in the store 6 will then determine the average from the stored information.

Although in this example the information retrieved by the formula has been obtained from the database 5, it could also be obtained from one or more data fields within the displayed form even if that information has not been stored on the database.

Also, in some cases the intermediate window 28 may not be necessary. Right clicking on the data field 26 could immediately bring up the Extra Information 30.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such as floppy disc, a hard disk drive, RAM, and CD-ROMs, as well as transmission-type media, such as digital and analog communications links.

We claim:

1. A system for enabling entry and/or display of data in a database, the system comprising a processor for controlling the display of a form having a number of data fields corresponding to data items stored or to be stored on a database; and a store for storing, for at least one data field, information enabling attributes relating to that data field to be displayed upon user command while the form continues to be displayed.

2. A system according to claim 1, wherein the stored information defines one or more data items from the database.

3. A system according to claim 1, wherein the processor provides a user interface to enable a user to define information which is stored in the store corresponding to the at least one data field.

4. A system according to claim 1, wherein the processor is adapted to respond to mouse commands, the user command comprising a right click of the mouse when the mouse icon is aligned with a data field.
